(19) United States
(12) Patent Application Publication
(10) Pub. No.: US 2009/0246302 A1
(43) Pub. Date: Oct. 1, 2009

(54) COMPOSITION AND METHOD FOR PROTECTING AGRICULTURAL CROPS AND/OR AGRICULTURAL PRODUCTS

(75) Inventors: Usha R. Pathipati, Hyderabad (IN); Devanand Peta, Hyderabad (IN)

Correspondence Address: EDWARDS ANGELL PALMER & DODGE LLP, P.O. BOX 55874, BOSTON, MA, 02205, US

(73) Assignee: COUNCIL OF SCIENTIFIC & INDUSTRIAL RESEARCH, New Delhi (IN)

(21) Appl. No.: 12/260,523

(22) Filed: Oct. 29, 2008

(30) Foreign Application Priority Data
Mar. 5, 2008 (IN) 516/DEL/2008

(51) Int. Cl. A01N 65/00

(52) U.S. Cl. 424/774

(57) ABSTRACT

The present invention provides a composition and a method for protecting agricultural crops and/or agricultural products against insects/pests. The said composition comprising an effective amount of extract obtained from Piper betle Linn. The plant material prepared in accordance with this invention is extremely effective in reducing insect populations and preventing their proliferation without risks to health or the environment.

### CROSS-REFERENCE TO RELATED APPLICATIONS

This application claims priority to Indian Patent Application No. 516/DEL/2008, filed on Mar. 5, 2008, the entire contents of which are incorporated herein by reference.

All documents cited or referenced herein, together with any manufacturer's instructions, descriptions, product specifications, and product sheets for any products mentioned herein, are hereby incorporated by reference, and may be employed in the practice of the invention.

### FIELD OF THE INVENTION

The present invention relates to a composition for protecting agricultural crops and/or agricultural products. More particularly, it relates to a method of protecting agricultural crops and/or agricultural products against insects and/or pests wherein the agricultural crops and/or products are treated with the said composition comprising an effective amount of extract obtained from Piper betle Linn. optionally along with acceptable carriers.

### BACKGROUND OF THE INVENTION

Many procedures are known in the prior art and commercially for insect control. The procedures commonly relied on involve treatment of the insect larvae with a toxic substance such as synthetic chemical including the use of petroleum-based chemicals which raise substantial environmental and health problems. The art continues to search for natural products and processes, which will enable man to effectively prevent insects to feed on without having adverse effects on environment.

(Shaaya, E. et al., 1997). Parmar et al. (1997) has demonstrated the 16 piper amides having insecticidal and insect antifeedant qualities. Many other workers have cited the antifungal, antibacterial and medicinal properties of piper betle. Santhanam et al. (1990) showed the wound healing activity of piper plant. Dubey et al. (1987) has reported the antifungal, physiochemical and phytotoxic properties of the essential oil of piper betle. Some workers have accounted the antibacterial activity of piper betle extract towards food borne pathogens and food spoilage microorganisms

Reference may be made to illustrate the effect of pesticides having played a significant part in increasing agricultural production and productivity. However continuous use of insecticides resulted in accumulation and concentration in food chains, subsequently leading to death in human beings. Another disadvantage associated with their continuous usage is that insects gradually become resistant to these insecticides and sometimes these insecticides destroy useful symbioants. Under these conditions the necessity of controlling insects by alternative method becomes imperative.

One of the best approaches to alternative insect control is by the use of chemicals, which influence insect chemosensory behavior such as attractants, repellents, stimulants, antifeedants and arrestants. Among these methods, antifeedants are effective and also considered as basic chemicals to control the insect population to get higher yield. Insect antifeedants are compounds with the ability to reduce or inhibit insect feeding without directly killing the insect. Such compounds offer a number of properties that are highly desirable in environmentally friendly crop protection agents.

Although the principle of insect control using antifeedants has been shown to work under field conditions, practical application of these compounds has until now been limited to a few examples, mainly consisting of extracts of the Neem tree containing the highly potent tetranortriterpene azadirachtin. Isman, M. B., 1998 have also demonstrated the efficacy of Neem and its related natural products as effective biopesticides. One of the factors hampering the introduction of insect antifeedants in crop protection is the limited availability of many of these compounds, which prevents their widespread application at low cost.

In efforts to solve these availability problems, synthetic approaches might provide an alternative to the isolation of antifeedants from natural sources. Since the total synthesis of natural insect antifeedants usually is too long and complex for this purpose, a more practical approach would be to directly purify them from natural sources, which have retained as much of the desired biological properties as possible. Wheeler, D. A., et al., 2000 have illustrated the effect of Trichilia mericana extract on feeding behavior of Asian armyworm, Spodoptera litura. Moreover, Passreiter, C. M., et al., 1997 have also demonstrated the antifeedant bioactivity of sesquiterpene lactones from Neurolaena lobata and their antagonism by g-aminobutyric acid. Apart from being potential crop protection agents themselves, such compounds may also serve as model compounds to investigate structure-activity relationships and thus to provide a basis for the design of more potent synthetic insect antifeedants.

Earlier many workers have worked on phytoecdysteroids, which are secondary compounds produced by plants from many different groups. These compounds mimic the activity of ecdysteroids, which are used by insects as molting hormone. These hormones interact with nuclear receptors and drive the expression of genes related to the shedding of the old cuticle and its replacement by a new one. Many phytophagous insects are equipped with taste receptor cells that are able to detect these compounds and to avoid such plants, before being intoxicated. Detecting such compounds has thus a protective value. Phytoecdysteroids could be used to protect plants in the field, provided that we find a way to use them effectively not only to prevent noxious insects from feeding but also move them away from the crops. Till date the whole leaf extract of Piper betle Linn has not been evaluated against agricultural pests.

Reference may be made to illustrate the toxicity effect of various plant oils as fumigants and contact insecticides for the control of stored-product insects and/or pests. Earlier little work has been done on the use of plants leaf crude extracts having toxicity against stored grain products. Using leaf extracts as toxicants is much cheaper and easier. Apart from this methyl bromide is critical to agriculture worldwide as a fumigant, post harvest storage protectant, and quarantine treatment to control many pests on various crops. However, the escape of some of the fumigant from stored grains into the atmosphere has led to its being declared an ozone depletor. And also, under the U.S. Clean Air Act, production and importation of methyl bromide will be banned in the United States in 2005. Hence it is now essential to develop a novel method to protect stored grain pests from infestation, which is inexpensive, easily adaptable, and harmless to humans, animals and to environment. For this use of natural plant extracts would be desirable alternative. There is no record of resistance to whole-plant extracts, possibly due to the synergistic action of many constituents. It is possible that phytotherapy produces fewer adverse effects than chemotherapy, because there are many active agents, each at a smaller dose than that required when a single agent is administered.

The Piper betle Linn. plant is a member of the Piperaceae family, which comprises approximately five genera and 1400 species. Some of these species are used in folk medicine to treat many diseases. Phytochemical investigations of piperaceae have shown the presence of metabolites from mevalonic acid (monoterpenes and sesquiterpenes), acetic acid/shikimic acid (flavonoids) and shikimic acid pathways (lignoids, arylpropanoids, amides).

The most frequent metabolites isolated are amides (cinnamoyl amides and alkyl amides). Aristolactams and other alkaloids also have been isolated along with flavonoids, flavones, dihydroflavones, chalcones and dihydroclacons. Methoxyflavonoids are often isolated but glycosylflavonoids are rare. Piper is one of the oldest plants respected as holy in India. It is consumed by itself, fresh or dried, as tea or in combination with betle nuts (Areca catechu). As a medicinal it is used for infections, stomach problems and as an aphrodisiac and life tonic. More recent work has shown betle leaves to strengthen the immune system and to inhibit certain cancer cells. The leaf contains about 0.2% essential oils, including eugenol, isoeugenol, allylpyrocatechol, chavicol, safrole, anethole and others. Piperin, the constituent that gives other piper species the hot taste, is not present in Piper betle. The major component of Piper betel is eugenol, (Dukes et al., 1992) which is also present in several other plant species. Due to the high volatility and short duration of activity and also due to it's non persistent nature, the use of eugenol on agricultural and stored commodities is not recommended. Earlier insecticidal activity of eugenol was also reported (Mohottalage 2007). However, the formulated composition of Piper betel Linn. crude extract has not been evaluated against stored grain insects and/or pests. The raw material of Piper betel is widely grown and the composition using rice bran is cost effective in protecting the agricultural products. The whole leaf extract of Piper betel Linn. has not been evaluated against stored grain insects and/or pests.

The bruchid beetle, Callosobruchus chinensis Linn. (Bruchidae: Coleoptera), is known to attack pigeon pea pods in the field and seeds in storage in India and also attack other pulse in storage. It causes appreciable damage to stored cowpea, grams, cotton, sorghum and maize seeds in storage. C. chinensis Linn female lays 34-113 white, elongate eggs singly on the seed surface and even more than one egg have been found sometimes laid on a single seed. The grubs feed on the inner contents of pulses and pupate inside them. Adult comes out of the seed by cutting circular hole of about 1 mm diameter on the seed and lives for 5-20 days.

Rice Weevil, Sitophilus oryzae (Coleoptera: Curculionidae): These insects damage whole grains or seeds. They are usually found in grain storage facilities or processing plants, infesting wheat, oats, rye, barley, rice, and corn. The egg, larva, and pupa stages of both weevils occur in the grain kernels and are rarely seen. Feeding is done within the grain kernel, and adults cut exit holes to emerge. They generally do not feed on flour or cereals unless it has become caked. Adult weevils are very similar. Both are dark reddish-brown and range in size from ⅛ to 3/16-inch long. They have a long snout projecting from the head and wing covers with distinct ridges. Females lay eggs on seeds, kernels or other suitable foods. The larvae chew into the seed and feed on the inside of whole kernels/seeds. There can be as many as three to five generations each year. Weevil-damaged grains are typically hollow and have small round emergence holes. Because they feed on whole grains, these insects are a problem in grain bins and warehouses, but it is possible to have infestations in homes. Most common sources are popcorn, birdseed, decorative Indian corn and nuts.

The khapra beetle, Trogoderma granarium (Dermestidae: Coleoptera), considered to be one of the world's most destructive pests of grain products and seeds, probably originated from regions now including India and Bangladesh, but has since spread to other areas including northern and eastern Africa, southern Europe and the Mediterranean region, the Mideast, and east into Asia. A female deposits up to 125 eggs, these being placed singly in the infested goods. The larva is a very serious stored product pest; the beetle itself does no damage it is found in warehouses, sites, mills, breweries, malt factories. It attacks all types of grain, malt cereal products, oilseed cake, groundnuts, fish meal, etc. Grain kernels are often hollowed out until only the husk remains the edges of jute sacks are often found to be thickly populated with larvae in infested stores. This species is a considered to be a dirty feeder, breaking or powdering more kernels than it consumes. They not only consume the grain, but may also contaminate it with body parts and setae that are known to cause adult and especially infant gastrointestinal irritation.

The rice moth, Corcyra cephalonica (stainton) (Galleriidae: Lepidoptera), color of adult is grayish brown and caterpillar is up to 15 mm long and white or cream. The caterpillars web tighter the grains hidden in the frass and feed within. Caterpillars produce a lot of dung, which can then be infested by other storage pests such as flour beetles. It attacks broken grains and flours especially the milled products that are heavily damaged if neglected. Adults do not feed on stored products, but larvae will feed on any coarse flour, processed foods, whole seed, even dried fruit, nuts chocolate, beans and most products manufactured from these ingredients. Adult moth laid their eggs directly on the material, usually at night, and over a two or three week period, will lay more than 400 eggs.

The castor semi looper, Achaea janata (Linnaeus) (Noctuidaes: Lepidoptera) is a major agricultural pest feeds on many different species of plants. Castor beans and croton are preferred hosts. Occasional hosts include banana, cabbage, Chinese cabbage, crown of thorns, Ficus, macadamia, mustard, poinsettia, rose, sugarcane and tomato as well as some legumes, teas and other Brassica species. This moth is widespread throughout the tropical and subtropical Pacific, in Australia, and the Orient. They feed on leaves of hosts. During population outbreaks, larvae consume most of the foliage leaving just veins and petioles. The entire life cycle from egg to adult takes place in 48-50 days. The population of this moth fluctuates from year to year in abundance and seasonal occurrence. Female lays eggs 2 to 5 days after emerging from the pupa and lay an average of 1305 eggs during their life time (Karmavati and Tobing, 1988). Eggs are laid during the night since the moths are nocturnal.

### OBJECTS OF THE INVENTION

The main object of the present invention is thus to provide a method of protecting agricultural crops and/or agricultural products.

Another object of the present invention is to provide a composition of natural origin to protect agricultural crops and/or agricultural products.

Yet another object of the present invention is to provide a method of preparation of the extract of Piper betle Linn.

### SUMMARY OF THE INVENTION

The present invention provides a composition which is useful in protecting agricultural crops and/or agricultural products. Further it provides a method of protecting agricultural crops and/or agricultural products. Also provided is a method of preparation of the extract of piper betle Linn.

Accordingly, the present invention provides a method of protecting agricultural crops and/or agricultural products against insects and/or pests wherein the agricultural crops and/or products are treated with the composition comprising an effective amount of extract obtained from Piper betle Linn. optionally along with acceptable carriers. This invention also provides a process for preparation of extract, which is prepared by milling the air-dried leaves of Piper betle Linn. to coarse particles and soxhlet extracted with acetone as solvent.

In an embodiment, the present invention provides a method of protecting agricultural crops and/or agricultural products against insects and/or pests wherein the agricultural crops and/or products are treated with the composition comprising an effective amount of extract obtained from Piper betle Linn. optionally along with acceptable carriers.

In another embodiment, the composition acts as an antifeedant and/or insecticide and/or repellent against insects and/or pests.

In yet another embodiment, the composition formulated as a compositional form selected from the group consisting of sprays, encapsulations, granulations, powders, liquids, solutions, suspensions, powders, pellets, bricks and briquettes.

In yet another embodiment, the extract of Piper betle Linn is extract of leaves of Piper betle Linn.

In yet another embodiment, insects and/or pests are Coleopterans and Lepidopterans.

In still another embodiment, the lepidopterans are Corcyra cephalonica and Achaea janata.

In still another embodiment, the agricultural crops are selected from a group consisting of Castor beans, croton, banana, cabbage, Chinese cabbage, crown of thorns, Ficus, macadamia, mustard, poinsettia, rose, sugarcane tomato, legumes, teas and Brassica species.

In still another embodiment, agricultural products are selected from a group consisting of pigeon pea pods, cow pea, grams, cotton, sorghum, maize seeds, all types of grains, malt cereal products, oil seed cakes, ground nuts, fish meal, coarse flour, processed foods, whole seeds, dried fruits, chocolate, beans and products manufactured from these ingredients.

Further in an embodiment, the present invention provides, a composition useful in protecting agricultural crops and/or agricultural products comprising an effective amount of extract obtained from Piper betle Linn. along with acceptable carriers.

In another embodiment, the composition comprises about 10-mg/100 μl (10% w/v) of the extract for antifeedant activity, 0.125% of the extract for insecticidal activity and 18% of the extract for 100 percent repellent activity.

In another embodiment the composition acts an antifeedant and/or insecticide and/or repellent against insects and/or pests and/or pests.

In still another embodiment, the composition is formulated as a compositional form selected from the group consisting of sprays, encapsulations, granulations, powders, liquids, solutions, suspensions, powders, pellets, bricks and briquettes.

In still another embodiment, the extract of Piper betle Linn is extract of leaves of piper betle Linn.

### DETAILED DESCRIPTION OF THE INVENTION

The biological material used in the present invention i.e., Piper betle Linn was procured from the local markets of Hyderabad, India. The commodity is a freely traded commodity in the local markets of India.

It has been found that the plant material prepared in accordance with this invention is extremely effective in reducing insect populations and preventing their proliferation without risks to health or the environment. The extract of the invention is useful in insect control.

The present invention provides a composition which is useful in protecting agricultural crops and/or agricultural products. Further it provides a method of protecting agricultural crops and/or agricultural products. Also provided is a method of preparation of the extract of Piper betle Linn.

The process comprises the shade drying the Piper betle leaves and crushing them to around 2 mm particles, further extracting the crushed leaves in a soxhelet apparatus by fractionating column chromatography method using acetone as solvent. The solvent is evaporated from the extract in a rotary evaporator and optionally re-dissolving the extract when used.

The invention is also related to a method of protecting agricultural crops and/or agricultural products against insects and/or pests which comprises applying to the said crops or products an effective amount of the composition comprising 0.05 to 25% of the crude extract obtained from Piper betle Linn. along with 99.95 to 75% of the acceptable carrier[s].

From the following examples, it will be seen that the invention is broadly applicable for the control and or management of various types of insects and/or pests thus protecting agricultural crops and/or agricultural products. The Piper betle Linn. plants may be used as bulk material in the form of milled dried leaves or vapor may also be used with corresponding results. It has been found according to the present invention that the composition has an adverse effect on insects and/or pests particularly in controlled environments such as stored commodity packaging, fumigation as well as crops.

The following examples are given by way of illustration of the present invention and therefore should not be construed to limit the scope of the present invention.

### Example 1

Plant material was prepared by harvesting leaves from the Piper betle Linn. and separated from their petioles at the base of the leaf blade. The harvest was then air dried in shade for 3 days at 28°±2° C. and milled to 2.0-mm particle size. The material was then filled inside a thimble and placed in the soxhlet apparatus and extracted with acetone as solvent. The extraction was preceded for about 15-18 hours at room temperature. The extract was then subjected to solvent evaporation under reduced pressure in a rotary evaporator at 50° C. The final product was weighed and re-dissolved in acetone to make required quantities of dilutions of the plant extract for the experimental use. % Yield−6.75 (dry weight of acetone extract/dry weight of test material)×100.

### Example 2

Antifeedant activity of the crude extract of piper plant was tested against the larvae of castor semilooper, Achaea janata (L). In the method, leaves were freshly collected from the laboratory fields. The leaves were cut into round discs measuring 2 cm dia and placed inside petri plates of 150 mm diameter, lined with a thin layer of adsorbent cotton, which was made wet by sprinkling water. The surfaces of the leaf discs were treated with 100 μl of the extract at concentrations of 40, 60, 80, and 100 (mg/ml) in acetone. Control discs were treated with acetone. After air drying for about 3 min each disc is placed inside a petri plate. One healthy third instar larvae of castor semi looper, starved for about 2 h were released into petri plate before closing the lid. The area of leaf fed by each insect (antifeedant activity) was checked after every 24 hrs of treatment. There were 60 replicates having single insect per replicate for each treatment of antifeedant activity. The results indicated that the crude extract at the concentration of 100 mg/ml showed 100% antifeedant activity.

### Example 3

The insecticidal property of the plant extract was tested in fumigation method with crude leaf extracts of Piper betle Linn. Material prepared as described in example 1. 50, 75, 100 and 125 mg/100 μl (w/v) of the extract in acetone was used in the treatments. Each concentration of 100 μl was applied individually on small cotton balls. After air-drying the sample, the cotton ball was placed in a container (100 cc capacity) having 20 grams of uninfested grain. Twenty pest insects were released into the container and the containers were made airtight by closing with lids. The mortality percentage was recorded after 24, 48 and 72 hours. For control, insects and/or pests were exposed to the cotton balls treated with acetone in the similar manner. All experiments were carried out at room temperature 28±2° C., 65-70% relative humidity. The method in this example was used against adults and larvae of Corcyra cephalonica, adults of Callosobruchus chinensis and Trogoderma granarium to control them by fumigation method. The application of 125-mg/100 μl of the compound was highly effective, produced 100% mortality against Callosobruchus chinensis beetles, Trogoderma granarium beetles, and Corcyra cephalonica larvae, after about 24 hours of treatment. For each treatment there were at least 15 replicates and each replicate consisted 20 adult unsexed insects.

### Example 4

Repellant activities of the piper crude leaf extracts were tested in Y-tube olfactometer. Material prepared as described in example 1. Responses of ten insects and/or pests to odor sources were assayed in a Y-shaped Pyrex glass olfactometer (5 mm i.d.; stem 10 cm; arms 10 cm at a 120° angle). Air drawn through the apparatus at 5 litres/min with a water aspirator carried samples from odor sources inside the arms, towards insects and/or pests released individually into the stem of the Y-tube. Each replicate employed a new odor source, Y-tube, and insect, and for each replicate, odor sources were randomly assigned to, and placed near, the orifice of the side arms on a small cotton ball. Before the application of the samples the insects and/or pests were released into the Y-tube, and ascertained their normal behavior. The response was observed till 20 min. All the experiments were carried at room temperature 28±2° C., 65-70% relative humidity, and 12:8 dark:light photoperiod. There were five replicates for each experiment and the experiments were repeated three times. 20 μl of each dilutions of piper betle crude leaf extract at the dosage of 160 and 180 mg/ml was tested against adults of Callosobruchus chinensis in Y-tube olfactometer. These two dilutions produced 85 and 100% repellency after 20 minutes of exposure respectively.

### Example 5

As in example 4, Piper betle Linn crude extract was fractionated to yield an active fraction by column chromatography. The crude dried extract of Piper betle L. 1.532 g was loaded on the silica column (mesh 100-200) and eluted with the following solvents. 100% Hexane F1 (300 ml), Hexane: CHCl3 F2 (98:2-100 ml), Hexane: CHCl3 F3 (96:4-200 ml), Hexane: CHCl3 F4 (94:6-200 ml), Hexane: CHCl3 F5 (92:8-200 ml), Hexane: CHCl3 F6 (90:10-300 ml), Hexane: CHCl3 F7 (80:20-100 ml), Hexane: CHCl3 F8 (60:40-100 ml), Hexane: CHCl3 F9 (50:50-100 ml), 100% CHCl3 F10-12 (300 ml), CHCl3: EtOAC F13 (80:20-100 ml), CHCl3: EtOAC F14 (60:40-100 ml), CHCl3: EtOAC F15 (20:80-100 ml), 100% EtOAC F16 (200 ml), EtOAC: Acetone F17 (80:20-100 ml), EtOAC: Acetone F18 (50:50-100 ml), Acetone F19 (300 ml), afforded nineteen fractions whose bioactivity was detected in four of them F3, F4, F5 and F6. These active fractions are pooled and separated on TLC using hexane, CHCl3, EtOAc, (4:0.5:0.5). The active fractions are further analyzed yielded a active compound eugenol. The active principle from the crude extract of P. betle leaf was identified as eugenol—4-Allyl-2-methoxyphenol,

### Eugenol:

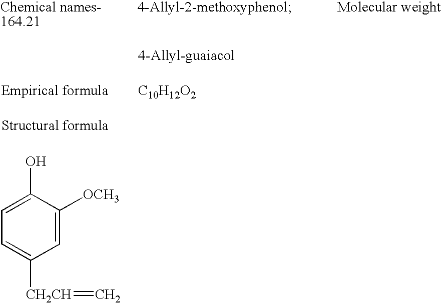

Due to the high volatility and short duration of activity and also due to it's non persistent nature of eugenol it was not considered for the development of an insecticide for stored product pests.

### Example 6

The crude extract of Piper betle tested in the laboratory, exhibited excellent insecticidal properties. The promising botanical insecticide was further evaluated at the field level using large-scale stored grain in the go downs of Central Ware House Corporation. Jute bags of 25 kg capacities were filled with stored grain and fumigated with the test extract at the rate of 1 g/kg grain. Adult insects grown in the laboratory at the rate of 150/kg grain were released in to each bag. Treated and untreated bags were kept away from the routine stacks to avoid the accidental spraying of the insecticide. Samples of 50 g from each bag were drawn using a probe at intervals of 24, 48, and 72 Hours. The samples were examined for presence of insects dead/alive and the amount of quantitative protection offered by the P. betle leaf crude extract employed was estimated. For observing the effects of the extracts on prolonged treatments and long term protection of the stored grain, the live insects were released at regular intervals and the duration of protection was recorded. Insecticidal activity of P. betle leaf crude extract at the above dosage was very effective at field conditions and the compound is more effective in the field level than the laboratory controlled conditions. There were six replicates for each treatment (Table. 2).

The antifeedant activity of the crude extract of P. betle was assessed against larvae of Achaea janata at field level to test potency of the extract in the natural environment. For this two different fields that are adjacent to each other, each with 100 m² area having 40 day old, 3 meter tall castor bean, (Ricinus communis L.) plants was selected. Each plot consisted 70-80 plants. In treated plot the plants were sprayed with P. betle leaf crude extract, at the rate of 1.0 g in 25 ml acetone/plant. Same amount of acetone was sprayed on plants in control plots. Third instar larvae of A. janata was released on the leaf surfaces in the both fields at the rate of 20 insects/plant. The crude leaf extract of P. betle showed excellent antifeedant activity at the dose employed by completely inhibiting the feeding of the pest even in field conditions (Table. 3).

### Results:

TABLE 1
Insecticidal activity of Piper betle leaf crude extract and its formulation
on agricultural product pests in laboratory bioassays.

| | Mean (%) mortality ^{b} of insects | | | |
|---|---|---|---|---|
| | | | Control | |
| | Treated | | | Rice bran |
| | Crude | Rice bran | | with |
| Insect pests ^{c} | extract ^{a} | formulation ^{a} | Acetone ^{a} | acetone ^{a} |

1 day

| | | | | |
|---|---|---|---|---|
| C. cephalonica larvae | 100 | 100 | 0 | 0 |
| C. chinensis adult | 100 | 100 | 0 | 0 |
| T. granarium adult | 100 | 100 | 0 | 0 |

2 days

| | | | | |
|---|---|---|---|---|
| C. cephalonica larvae | 100 | 100 | 0 | 0 |
| C. chinensis adult | 100 | 100 | 0 | 0 |
| T. granarium adult | 100 | 100 | 0 | 0 |

3 days

| | | | | |
|---|---|---|---|---|
| C. cephalonica larvae | 100 | 100 | 0 | 0 |
| C. chinensis adult | 100 | 100 | 0 | 0 |
| T. granarium adult | 100 | 100 | 0 | 0 |

1^{st} week

| | | | | |
|---|---|---|---|---|
| C. cephalonica larvae | 100 | 100 | 0 | 0 |
| C. chinensis adult | 100 | 100 | 0 | 0 |
| T. granarium adult | 100 | 100 | 0 | 0 |

2^{nd} week

| | | | | |
|---|---|---|---|---|
| C. cephalonica larvae | 96 | 100 | 0 | 0 |
| C. chinensis adult | 100 | 100 | 0 | 0 |
| T. granarium adult | 81 | 100 | 0 | 0 |

3^{rd} week

| | | | | |
|---|---|---|---|---|
| C. cephalonica larvae | 74 | 82 | 0 | 0 |
| C. chinensis adult | 63 | 66 | 0 | 0 |
| T. granarium adult | 40 | 53 | 0 | 0 |

4^{th} week

| | | | | |
|---|---|---|---|---|
| C. cephalonica larvae | 51 | 64 | 0 | 0 |
| C. chinensis adult | 35 | 42 | 0 | 0 |
| T. granarium adult | 23 | 29 | 0 | 0 |

^{a} Each extract applied to each treatment in 1 g/kg grain/1000 cc. Same amount of acetone treated as control
^{b} Each datum represents the mean of 15 replicates (n = 150/replicate)
^{c} Every week removing dead/alive insects and introducing fresh insects to the bags.

As evident from the foregoing examples, the composition of the present invention exhibits synergy and therefore neither it is merely an admixture nor the mere new use of a known substance. Accordingly, the claimed composition is a synergistic composition.

TABLE 2
Insecticidal activity of Piper betle leaf crude extract and its
formulation on agricultural product pests field bioassays.

| | Mean (%) mortality ^{b} of insects | | | |
|---|---|---|---|---|
| | | | Control | |
| | Treated | | | Rice bran |
| | Crude | Rice bran | | with |
| Insect pests ^{c} | extract ^{a} | formulation ^{a} | Acetone ^{a} | acetone ^{a} |

1^{st} week

| | | | | |
|---|---|---|---|---|
| C. cephalonica larvae | 100 | 100 | 0 | 0 |
| C. chinensis adult | 100 | 100 | 0 | 0 |
| T. granarium adult | 100 | 100 | 0 | 0 |

2^{nd} week

| | | | | |
|---|---|---|---|---|
| C. cephalonica larvae | 100 | 100 | 0 | 0 |
| C. chinensis adult | 93 | 100 | 0 | 0 |
| T. granarium adult | 90 | 100 | 0 | 0 |

3^{rd} week

| | | | | |
|---|---|---|---|---|
| C. cephalonica larvae | 89 | 100 | 0 | 0 |
| C. chinensis adult | 77 | 100 | 0 | 0 |
| T. granarium adult | 51 | 76 | 0 | 0 |

4^{th} week

| | | | | |
|---|---|---|---|---|
| C. cephalonica larvae | 66 | 79 | 0 | 0 |
| C. chinensis adult | 53 | 76 | 0 | 0 |
| T. granarium adult | 42 | 56 | 0 | 0 |

5^{th} week

| | | | | |
|---|---|---|---|---|
| C. cephalonica larvae | 31 | 69 | 0 | 0 |
| C. chinensis adult | 39 | 56 | 0 | 0 |
| T. granarium adult | 20 | 43 | 0 | 0 |

^{a} Extract applied at a dosage of 25 g/25 kg grain/25000 cc. Same amount of acetone treated as controls
^{b} Each datum represents the mean of 6 replicates (n = 3750/replicate)
^{c} Every week removing dead/alive insects and introducing fresh insects into the bags.

TABLE 3
Antifeedant activities against third instar larvae of Achaea janata
in laboratory and field level by leaf spraying method.

| | Mean (%) Antifeedant activity | |
|---|---|---|
| Test extract | At laboratory level^{a} | At field level^{b} |
| At 4 mg/disc (21 cm²) | 57 | |
| At 6 mg/disc (21 cm²) | 85 | |
| At 8 mg/disc (21 cm²) | 92 | |
| At 10 mg/disc (21 cm²) | 100 | |
| Control | 0 | |
| At 7 mg/cm² | | 95 percent of the leaf |
| | | remained untouched. |
| Control | | Normal feeding. |

^{a}Laboratory level
Each extract sprayed separately on disc, mg in 100 μl acetone/21 cm². Same amount of acetone treated as controls. Each datum represents the mean of 60 replicates (n = 1/replicate)
^{b}Field level
Extract sprayed separately on plant 1.0 g in 25 ml acetone/plant. (Total 70-80 plants/100 m²)
A total of 75 g of P. betle leaf crude extract in 1.87 liter Acetone/100 m²area field. Same amount of acetone treated as controls. Each datum represents the mean of 3 replicates (n = 1500/replicate)

### Example 7

The composition for protecting agricultural products was prepared. A new method was employed using rice bran, as carrier material. 500 g of clean and uncontaminated rice bran collected from the rice mills was completely dehydrated by sun drying. 25 g of the botanical extract of the P. betel in 125 ml of acetone was sprayed uniformly on to the rice bran. Mixed manually and allowed to shade dry for about 20 min.

Initially for the laboratory trials the composition containing 0.75 g, and 1 g botanical in the 20 g of rice bran was prepared individually using 5 ml of acetone was then mixed uniformly in 1 kg clean uninfested grain, which was filled in jute bags of 1 kg capacity. For controls, the rice bran treated with the same amount of acetone alone was set up in the similar manner. The mortality percentage was recorded after 24, 48 and 72 hours. All experiments were carried out at room temperature 28±2° C., 65-70% relative humidity. The method in this example was used against adults and larvae of Corcyra cephalonica, adults of Callosobruchus chinensis, Sitophilus oryzae and Trogoderma granarium to control (Table 4).

TABLE 4
Comparison of toxicities of Piper betel formulation and Eugenol
against certain stored grain pests in laboratory trials.

| | Mean (%) mortality of insects | | | |
|---|---|---|---|---|
| | Treated at the | | Treated at the | |
| | dosage of 750 mg/kg | | dosage of 1 g/kg | |
| | | P. betel | | P. betel |
| Insect pests | Eugenol | formulation | Eugenol | formulation |

1^{st} week

| | | | | |
|---|---|---|---|---|
| C. cephalonica larvae | 100 | 100 | 100 | 100 |
| C. chinensis adult | 100 | 100 | 100 | 100 |
| T. granarium adult | 100 | 100 | 100 | 100 |
| S. oryzae | 100 | 100 | 100 | 100 |

2^{nd} week

| | | | | |
|---|---|---|---|---|
| C. cephalonica larvae | 100 | 100 | 100 | 100 |
| C. chinensis adult | 100 | 100 | 100 | 100 |
| T. granarium adult | 100 | 100 | 100 | 100 |
| S. oryzae | 100 | 100 | 100 | 100 |

3^{rd} week

| | | | | |
|---|---|---|---|---|
| C. cephalonica larvae | 53.3 | 86.3 | 74 | 100 |
| C. chinensis adult | 58.4 | 100 | 63 | 100 |
| T. granarium adult | 26 | 80 | 40 | 100 |
| S. oryzae | 40 | 60 | 40 | 100 |

4^{th} week

| | | | | |
|---|---|---|---|---|
| C. cephalonica larvae | 13.3 | 46 | 29 | 100 |
| C. chinensis adult | 20 | 62 | 35 | 100 |
| T. granarium adult | 13.3 | 20 | 23 | 100 |
| S. oryzae | 20 | 44 | 35 | 64 |

5^{th} week

| | | | | |
|---|---|---|---|---|
| C. cephalonica larvae | 0 | 33.3 | 13.3 | 100 |
| C. chinensis adult | 0 | 42 | 20 | 100 |
| T. granarium adult | 0 | 20 | 0 | 53.3 |
| S. oryzae | 0 | 20 | 25 | 45 |

6^{th} week

| | | | | |
|---|---|---|---|---|
| C. cephalonica larvae | 0 | 0 | 0 | 33.3 |
| C. chinensis adult | 0 | 13.3 | 0 | 46 |
| T. granarium adult | 0 | 0 | 0 | 20 |
| S. oryzae | 0 | 0 | 0 | 26.6 |

### Example 8

The composition of Piper betel tested in the laboratory, exhibited excellent insecticidal properties. The promising botanical insecticide was further evaluated at the field level using large-scale stored grain in the go downs of Central Ware House Corporation. Jute bags of 25 kg capacities were filled with stored grain and the composition was mixed at the rate of 500 g/25 kg grain. Adult insects grown in the laboratory at the rate of 150/kg grain were released in to each bag. Treated and untreated bags were kept away from the routine stacks to avoid the accidental spraying of the insecticide. Samples of 50 g from each bag were drawn using a probe at intervals of 24, 48, and 72 hours. The samples were examined for presence of insects dead/alive and the amount of quantitative protection offered by the P. betel leaf composition employed was estimated. For observing the effects of the extracts on prolonged treatments and long term protection of the stored grain, the live insects were released at regular intervals (weeks) and the duration of protection was recorded (Table 5).

TABLE 5
Comparative data on toxicities of Piper betel
formulation and Eugenol in CWC Warehouses (field
evaluation) against pests of stored grains.

Mean (%) mortality of insects
Treated at the dosage of 25 mg/25 Kg

| | | |
|---|---|---|
| Insect pests | Eugenol | P. betel formulation |

1^{st} week

| | | |
|---|---|---|
| C. cephalonica larvae | 100 | 100 |
| C. chinensis adult | 100 | 100 |
| T. granarium adult | 100 | 100 |
| S. oryzae | 100 | 100 |

2^{nd} week

| | | |
|---|---|---|
| C. cephalonica larvae | 100 | 100 |
| C. chinensis adult | 100 | 100 |
| T. granarium adult | 100 | 100 |
| S. oryzae | 100 | 100 |

3^{rd} week

| | | |
|---|---|---|
| C. cephalonica larvae | 89 | 100 |
| C. chinensis adult | 100 | 100 |
| T. granarium adult | 72 | 100 |
| S. oryzae | 85 | 100 |

4^{th} week

| | | |
|---|---|---|
| C. cephalonica larvae | 66 | 100 |
| C. chinensis adult | 53 | 100 |
| T. granarium adult | 42 | 100 |
| S. oryzae | 50 | 79 |

5^{th} week

| | | |
|---|---|---|
| C. cephalonica larvae | 23 | 100 |
| C. chinensis adult | 39 | 100 |
| T. granarium adult | 20 | 96 |
| S. oryzae | 35 | 69 |

6^{th} week

| | | |
|---|---|---|
| C. cephalonica larvae | 0 | 65 |
| C. chinensis adult | 12.4 | 56 |
| T. granarium adult | 0 | 43 |
| S. oryzae | 0 | 60 |

7^{th} week

| | | |
|---|---|---|
| C. cephalonica larvae | 0 | 42 |
| C. chinensis adult | 0 | 33.3 |
| T. granarium adult | 0 | 20 |
| S. oryzae | 0 | 35 |

### Advantages:

(i) The present invention provides a new method to control insect pests of agricultural and stored product pests.
(ii) It minimize the usage of chemical pesticides in agricultural fields and storage warehouses and provides composition that has no or less environment impact.
(iii) Ready availability of the required preparations.
(iv) Non hazards to humans, animals and to environment.
(v) Involves a new approach to obtain and manufacture natural antifeedant and/or insecticide and/or repellent compounds from aromatic plants.
(vi) Raw material is available abundantly.

1. A composition for protecting agricultural crops and/or agricultural products against insects and/or pests wherein the composition comprises 0.05 to 25% of the crude extract obtained from Piper betle Linn. along with 99.95 to 75% of the acceptable carrier[s].

2. A composition according to claim 1, wherein the extract is obtained from the leaves of the plant Piper betle Linn.

3. A composition according to claim 1, wherein the crude extract is fractionated by column chromatography.

4. A composition according to claim 1, wherein the carrier material is rice bran.

5. A composition according to claim 1, wherein the composition acts as an antifeedant and/or insecticide and/or repellent against insects and/or pests.

6. A composition according to claim 5, wherein the composition having about 10% to 25% of the extract exhibits 100% antifeedant activity.

7. A composition according to claim 5, wherein the composition having about 0.050% to 0.125% of the extract exhibits 100% insecticidal activity.

8. A composition according to claim 5, wherein the composition having about 12% to 18% of the extract exhibits 100% repellent activity.

9. A composition according to claim 1, wherein the composition is formulated in a form selected from the group consisting of sprays, encapsulations, granulations, powders, liquids, solutions, suspensions, powders, pellets, bricks and briquettes.

10. A composition according to claim 1, wherein the agricultural crops are selected from the group consisting of Castor beans, croton, banana, cabbage, Chinese cabbage, crown of thorns, Ficus, macadamia, mustard, poinsettia, rose, sugarcane tomato, legumes, teas and Brassica species.

11. A composition according to claim 1, wherein the agricultural products are selected from a group consisting of pigeon pea pods, cow pea, grams, cotton, sorghum, maize seeds, all types of grains, malt cereal products, oil seed cakes, ground nuts, fish meal, coarse flour, processed foods, whole seeds, dried fruits, chocolate, beans and products manufactured from these ingredients.

12. A composition according to claim 1, wherein the insects and/or pests are Coleopterans and Lepidopterans.

13. A composition according to claim 12, wherein the coleopterans are Callosobruchus chinensis, Sitophilus oryzae and Trogoderma granarium.

14. A composition as according to claim 12, wherein the lepidopterans are Corcyra cephalonica and Achaea janata.

15. A process for the preparation of the crude extract of the plant Piper betle Linn, wherein the steps comprise:
[a] shade drying the Piper betle leaves and crushing them to around 2 mm particles;
[b] extracting the crushed leaves as obtained in step [a] in a soxhelet apparatus using acetone as solvent to obtain the extract;
[c] evaporating the solvent from the extract as obtained in step [b] in a rotary evaporator and optionally re-dissolving the extract when used.

16. A method of protecting agricultural crops and/or agricultural products against insects and/or pests which comprises applying to the said crops or products an effective amount of the composition comprising 0.05 to 25% of the crude extract obtained from Piper betle Linn. along with 0.02 to 10% of the acceptable carrier[s].

17. A method according to claim 16, wherein the carrier material is rice bran.

18. A method according to claim 16, wherein the composition acts as an antifeedant and/or insecticide and/or repellent against insects and/or pests.

19. A method according to claim 18, wherein the composition having about 10% to 25% of the extract exhibits 100% antifeedant activity.

20. A method according to claim 18, wherein the composition having about 0.050% to 0.125% of the extract exhibits 100% insecticidal activity.

21. A method according to claim 18, wherein the composition having about 12% to 18% of the extract exhibits 100% repellent activity.

22. A method according to claim 16, wherein the agricultural crops are selected from the group consisting of Castor beans, croton, banana, cabbage, Chinese cabbage, crown of thorns, Ficus, macadamia, mustard, poinsettia, rose, sugarcane tomato, legumes, teas and Brassica species.

23. A method according to claim 16, wherein the agricultural products are selected from a group consisting of pigeon pea pods, cow pea, grams, cotton, sorghum, maize seeds, all types of grains, malt cereal products, oil seed cakes, ground nuts, fish meal, coarse flour, processed foods, whole seeds, dried fruits, chocolate, beans and products manufactured from these ingredients.
